(19) United States
(12) Patent Application Publication
(10) Pub. No.: US 2024/0359509 A1
(43) Pub. Date: Oct. 31, 2024

(54) PNEUMATIC VEHICLE TIRE

(71) Applicant: Continental Reifen Deutschland GmbH, Hannover (DE)

(72) Inventors: Ahmet Özüduru, Hannover (DE); Eugen Henze, Wedemark (DE); Lubos Kuniak, Ladce (SK)

(73) Assignee: Continental Reifen Deutschland GmbH, Hannover (DE)

(21) Appl. No.: 18/572,062

(22) PCT Filed: Dec. 14, 2021
(86) PCT No.: PCT/DE2021/200260

§ 371 Date: Dec. 19, 2023

(30) Foreign Application Priority Data
Jun. 28, 2021 (DE) 10 2021 206 642.9

(51) Int. Cl. B60C 13/02; B60C 13/00

(52) U.S. Cl. CPC B60C 13/02; B60C 13/001

(57) ABSTRACT

A pneumatic vehicle tire having a tread, a belt assembly, a radial carcass, and having sidewalls which in each case in their radially outer region have at least two rows of parallelogram-shaped elevations with a height of 0.80 mm to 1.50 mm, determined in relation to the remaining level of the sidewall, said rows running so as to be concentric with the annular shape of the sidewall, wherein in which intermediate spaces are present between the elevations within one row and between mutually adjacent rows. The rows of elevations are mutually offset in the circumferential direction of the sidewall, with the elevations overlapping one another, wherein the intermediate spaces between the elevations are also mutually offset in the circumferential direction from row to row, so as not to be co-aligned.

### CROSS-REFERENCE TO RELATED APPLICATIONS

The present application is a National Stage Application under 35 U.S.C. § 371 of International Patent Application No. PCT/DE2021/200260 filed on Dec. 14, 2021, and claims priority from German Patent Application No. 10 2021 206 642.9 filed on Jun. 28, 2021, the disclosures of which are herein incorporated by reference in their entireties.

### TECHNICAL FIELD

The invention relates to a pneumatic vehicle tire having a tread, a belt assembly, a radial carcass, and having sidewalls which in each case in their radially outer region have at least two rows of parallelogram-shaped elevations with a height of 0.80 mm to 1.50 mm, determined in relation to the remaining level of the sidewall, said rows running so as to be concentric with the annular shape of the sidewall, wherein intermediate spaces having in each case in particular constant widths are present between the elevations within one row and between mutually adjacent rows.

### BACKGROUND

A pneumatic vehicle tire of this type is known, for example, from EP 3 129 241 B1. The sidewalls of the pneumatic vehicle tire in their radially outer region are reinforced with a protective layer of rubber, which locally thickens the sidewall and is divided by a network of incisions consisting of at least one circumferential incision in the circumferential direction of the sidewall and a plurality of incisions in block elements extending in the radial direction, therefore in elevations. The depth of the incisions at least in some regions is not more than 50% of the thickness of the protective layer at the point of the profile of the respective incision. In sidewalls which are provided with rubber protective layers in this manner, the risk of damage to the carcass insert running below the sidewalls, for example when the tire comes into contact with curbs and the like, is noticeably reduced. The narrow mesh ensures a great flexibility of the protective layer, which, however, comes at the expense of the robustness of the block-like structure.

### SUMMARY

The invention is based on the object of increasing the robustness of the block-like structure in a pneumatic vehicle tire of the type mentioned above, without having to accept any loss of flexibility.

The object is achieved according to the invention in that the rows of elevations are mutually offset in the circumferential direction of the sidewall, with the elevations overlapping one another, wherein the intermediate spaces between elevations are also mutually offset in the circumferential direction from row to row, so as not to be co-aligned.

Due to the mutual offset, the individual elevations are structurally very robust, in particular due to the possibility of optimal mutual support as a result of the intermediate spaces which are mutually offset in the radial direction. These staggered intermediate spaces between the elevations in the individual rows still ensure a high degree of flexibility of the sidewall under loads.

In a preferred embodiment, the elevations in all rows when viewed from above have a parallelogram shape with two acute angles of 30° to 70° which the angles in the elevations match within a row and preferably in the elevations of all rows, wherein the elevations in all rows are identically aligned in the circumferential direction. An embodiment of this type facilitates the design and arrangement of the elevations with intermediate spaces between the rows, which are mutually offset in the circumferential direction without adjoining one another.

In another preferred embodiment, which moreover can be designed in a visually very appealing manner, the elevations in all rows are rectangular, in particular square, when viewed from above.

A particularly uniform distribution of the rubber material claimed by the elevations is achieved when all rows within a sidewall portion which extends in the circumferential direction have the same number of elevations. In this context, it is furthermore advantageous if the elevations in the rows within a sidewall portion which extends in the circumferential direction are each of identical design, and all of the elevations are preferably designed in the same manner.

Further advantageous design embodiments of the elevations enhance their robustness and their protective effect. According to one of these design embodiments, the elevations in the circumferential direction of the sidewall have a length of 15.00 mm to 30.00 mm, in particular of 20.00 mm, and furthermore in the radial direction have a width of 5.00 mm to 12.00 mm. When viewed from above, square elevations preferably have an edge length of 6.00 mm to 20.00 mm.

Furthermore, elevations that have lateral faces which run at an angle of 30° to 90°, in particular up to 60°, in relation to the level of the sidewall, are particularly robust in terms of deformations. At angles of less than 90°, the lateral faces are tilted outward.

The widths of the intermediate spaces between the elevations within a row are 1.00 to 7.00 mm, in particular at least 2.00 mm, and between adjacent rows are 1.00 to 5.00 mm, in particular at least 1.5 mm. Widths of this order are particularly advantageous for a good flexibility of the sidewall under the stresses occurring during the operation of the tires.

With a view to a good protective effect of the elevations when contacting curb edges and the like, a relatively large radial region of the sidewall should be covered by elevations. It is therefore advantageous if the number of rows is three to five, and if the rows on the sidewall cover a sidewall portion which in the radial direction is between a first height, which is 40% to 50% of the cross-sectional height of the tire, and a second height, which is between 80% and 97% of the cross-sectional height of the tire. In this respect, it is additionally advantageous if the rows run continuously over at least a major part of the circumference of the sidewall, in particular over at least three quarters of the circumference.

In order to moreover make the elevations and the intermediate spaces between the elevations visually appealing, in a preferred embodiment intermediate spaces between the elevations and between adjacent rows are provided with a crosshatch of a multiplicity of parallel micro-ribs with a preferably dome-shaped or triangular cross section and with a maximum height of 0.20 mm to 0.30 mm in relation to the sidewall level, and a likewise width at their base. Such micro-ribs can also run over surfaces of elevations, an extremely attractive design of the sidewall being achievable as a result.

### BRIEF DESCRIPTION OF THE DRAWINGS

Further features, advantages and details of the invention will now be described in more detail on the basis of the schematic drawing, which illustrates exemplary embodiments. In the drawing:

FIG. 1 shows a cross section of one half of a pneumatic vehicle tire;

FIG. 2 shows an enlarged illustration of a fragment of the outer contour in the region of the sidewall of the pneumatic vehicle tire from FIG. 1;

FIG. 3 shows a view of a circumferential portion of the sidewall having an embodiment of the invention; and

FIG. 4 shows a view of a circumferential portion of a sidewall having a further embodiment of the invention.

### DETAILED DESCRIPTION

Pneumatic vehicle tires embodied according to the invention are radial tires for motor vehicles, preferably tires for passenger motor vehicles, SUVs, vans or light trucks.

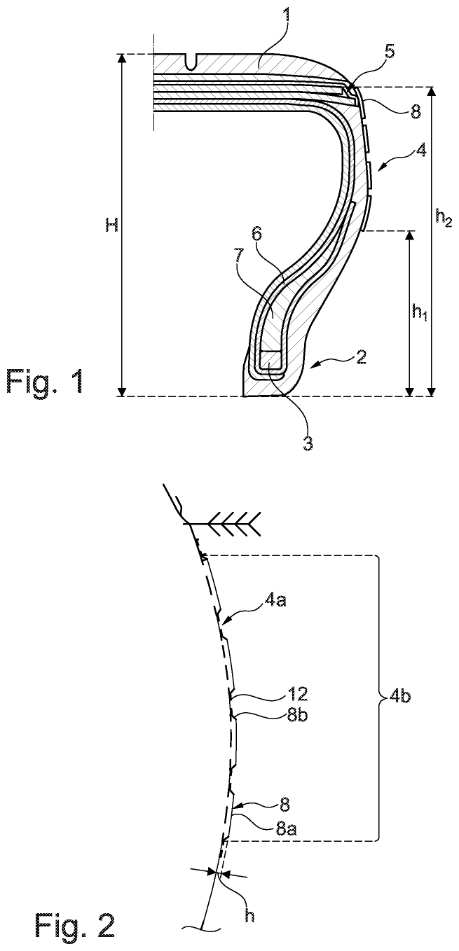

The pneumatic vehicle tire shown in FIG. 1 has as substantial components a tread 1, which in a way not shown is provided with a tread profile, bead regions 2 with bead cores 3, sidewalls 4, a multi-layer belt assembly 5, and a carcass insert 6. Installed radially outside the bead core 3 is a core profile 7 which, conjointly with the bead core 3, encircles the tire.

The sidewalls 4 consist of a rubber material and run along the outside of the tire along the carcass insert 6, between the belt assembly 5 and the bead regions 2. In order to facilitate a low rolling resistance of the pneumatic vehicle tire by reducing weight, the sidewalls 4 are kept relatively thin. In the case of thin sidewalls 4, the risk that the carcass insert 6 is also damaged when contacting curb edges or the like is greater than in the case of thicker sidewalls.

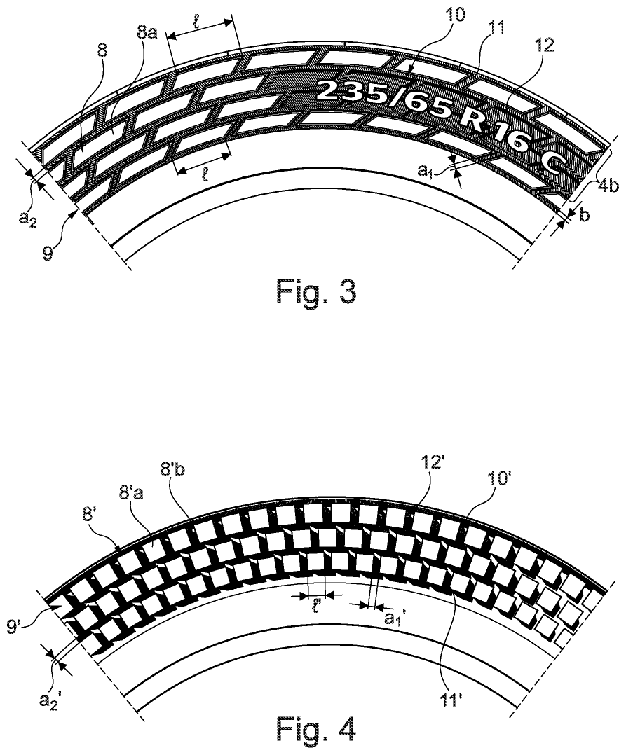

In order to make the sidewalls 4 more robust in relation to external influences, they are reinforced, as shown in particular in FIG. 3 and FIG. 4, with rows 9, 9′ of block-shaped elevations 8, 8′ which run in parallel and next to one another and protrude from the remaining sidewall level 4a (FIG. 2) and in relation to this level have a top face 8′a with a constant height h, the latter being 0.80 mm to 2.00 mm, in particular 1.00 mm. The elevations 8, 8′ have lateral faces 8b, 8′b descending from the top face 8a, 8′a to the sidewall level 4a. In the embodiment according to FIG. 2 and FIG. 3, the lateral faces 8b are inclined at an angle of 30° to 60°, in particular 45°, in relation to the sidewall level 4a; in the embodiment according to FIG. 4, the lateral faces 8′b are inclined at an angle of 70° to 90° in relation to the sidewall level 4a. The rows 9, 9′, the number of which is at least two and in particular up to five, follow concentrically the annular shape of the sidewall 4 and are therefore annular segments which run continuously within a wider sidewall portion 4b that comprises all of the rows 9, 9′ and runs over the circumference of the sidewall 4, or part of the circumference, for example at least three quarters of the circumference.

As shown in particular in FIG. 1, the sidewall portion 4b covers a sidewall region in the radial direction between a first height h₁, which is 30% to 50% of the cross-sectional height H and a second height h₂, which is 80% to 97% of the cross-sectional height H.

In the preferred embodiment shown in FIG. 3 and FIG. 4, the number of elevations 8, 8′ in rows 9, 9′ is identical within a sidewall portion 4b, wherein elevations 8, 8′ of identical size and identical design are preferably present in a parallelogram shape, when viewed from above, within each row 9, 9′.

FIG. 3 shows an embodiment having parallelogram-shaped elevations 8 with two acute angles from 30° to 70° and two corresponding obtuse angles, two longer sides which are slightly curved in the circumferential extent of the sidewall 4 and in accordance with the annular shape, having a length l of 15.00 mm to 30.00 mm, in particular at least 20.00 mm, determined along their chord, wherein the length l of the elevations 8 located within the radially innermost row 9 is less than the length l of the elevations 8 in the radially outermost row 9 and increases from the innermost to the outermost. The width b of the elevations 8, determined in the radial direction, is 5.00 mm to 12.00 mm, wherein the width b is identical in all or some rows 9, or increases from the radially innermost row 9 in the direction toward the radially outermost row 9.

Intermediate spaces 11 are located between the elevations 8 within the rows 9, the width a₁ of said intermediate spaces 11 at the sidewall level 4a being in the order of 1.00 mm to 5.00 mm, in particular at least 2.00 mm, and preferably being constant between the elevations 8 within a specific row 9. Also present between adjacent rows 9 are intermediate spaces 12, the width a₂ of which being 1.00 mm to 5.00 mm, in particular 2.00 mm to 5.00 mm, wherein the width a₂ can be increasingly larger the further radially outside a row 9 is located.

The mutual arrangement of the elevations 8 in the adjacent rows 9 is of such a type that they are mutually offset from row 9 to row 9 in the same circumferential direction over, for example, 25% to 50% of their lengths L and therefore overlap one other in such a manner that no co-aligned intermediate spaces 11 are present.

The intermediate spaces 11, 12 between the elevations 8 and between adjacent rows 9 in the preferred embodiment shown in FIG. 3 are provided with a crosshatch of parallel running micro-ribs 10 with a dome-shaped or triangular cross section, with a maximum height of 0.20 mm to 0.30 mm in relation to the other sidewall level 4a, and a likewise width at their base. These micro-ribs 10 can furthermore have a mutual spacing of 0.10 mm to 0.20 mm at their base. For design reasons, it can also be provided that micro-ribs 10 extend beyond the surfaces of the elevations 8. Additionally, a narrow, approximately 1.50 mm to 2.00 mm wide boundary strip can be provided radially within the radially innermost row 9 and radially outside the radially outermost row 9 with micro-ribs 10, as described. As shown in FIG. 3, an inscription of any characters can be configured as local additional elevations across one row 9 or across a plurality of rows 9.

Instead of the parallelogram shape with two acute and two obtuse angles when viewed from above, as illustrated and described, the elevations 8 may also have the shape of rhombs. Alternatively, the elevations have the shape of rectangles which are elongate in the circumferential direction.

FIG. 4 shows a design which, when viewed from above, has square elevations 8′ with an edge length I′ from 6.00 mm to 20.00 mm. The further radially inside the elevations 8′ are, the smaller their edge length l′. The intermediate spaces 11′, 12′ between the elevations 8′ have a width a₁′ of 3.0 mm to 7.00 mm; the width a₂′ between adjacent rows 9′ is 1.5 mm to 5.00 mm. Intermediate spaces 11′, 12′ between elevations 8′ are provided with a hatching of micro-ribs 10′ running parallel to one another in such a manner that, when viewed onto the sidewall 4, the impression of cube-shaped elevations 8′ is created. In this case, micro-ribs 10′ can also run across surfaces of elevations 8′. The design of the micro-ribs 10′ corresponds to that of the micro-ribs 10.

In another embodiment not shown, the number of elevations provided in one row differs from the number of elevations provided in at least one further row, for example in that one elevation is in each case present instead of the two elevations otherwise provided. The dimensions of the elevations and the intermediate spaces between them are mutually adapted in order to ensure mutual overlapping of the elevations from the adjacent rows.

### LIST OF REFERENCE SIGNS

1 . . . Tread
2 . . . Bead region
3 . . . Bead core
4 . . . Sidewall
4a . . . Sidewall level
4b . . . Sidewall portion
5 . . . Belt assembly
6 . . . Radial carcass
7 . . . Core profile
8, 8′ . . . Elevation
8a, 8′a . . . Top face
8b, 8′b . . . Lateral face
9, 9′ . . . Row
10, 10′ . . . Micro-rib
11, 12, 11′, 12′ . . . Intermediate space
a₁, a₂, a₁′, a₂′, b . . . Width
H . . . Cross-sectional height
h₁, h₂ . . . Height
l . . . Length
l′ . . . Edge length

1.-14. (canceled)

15. A pneumatic vehicle tire comprising a tread, a belt assembly, a radial carcass, and sidewalls, each sidewall in its radially outer region having at least two rows of parallelogram-shaped elevations with a height of 0.80 mm to 1.50 mm, determined in relation to a remaining level of the sidewall, said rows running so as to be concentric with an annular shape of the sidewall,
wherein intermediate spaces are present between the elevations within one row and between mutually adjacent rows,
wherein the rows of elevations are mutually offset in the circumferential direction of the sidewall, with the elevations overlapping one another, wherein the intermediate spaces between elevations are also mutually offset in the circumferential direction from row to row, so as not to be co-aligned.

16. The pneumatic vehicle tire as claimed in claim 15, wherein the intermediate spaces between the elevations have constant widths.

17. The pneumatic vehicle tire as claimed in claim 15, wherein the elevations in all rows when viewed from above have a parallelogram shape with two acute angles of 30° to 70°, which angles in the elevations match within all rows, wherein the elevations in all rows are identically aligned in the circumferential direction.

18. The pneumatic vehicle tire as claimed in claim 15, characterized in that the elevations in all rows are rectangular when viewed from above.

19. The pneumatic vehicle tire as claimed in claim 15, wherein all rows within a sidewall portion which extends in the circumferential direction have the same number of elevations.

20. The pneumatic vehicle tire as claimed in claim 15, wherein the elevations in the rows within a sidewall portion which extends in the circumferential direction are in each case of identical design.

21. The pneumatic vehicle tire as claimed in claim 15, wherein the elevations in the circumferential direction of the sidewall have a length of 15.00 mm to 30.00 mm, and in the radial direction have a width of 5.00 mm to 12.00 mm.

22. The pneumatic vehicle tire as claimed in claim 21, wherein the elevations in the circumferential direction of the sidewall have a length of 20.00 mm to 30.00 mm.

23. The pneumatic vehicle tire as claimed in claim 18, wherein, when viewed from above, the rectangular elevations are square elevations and have an edge length of 6.00 mm to 20.00 mm.

24. The pneumatic vehicle tire as claimed in claim 15, wherein the elevations have lateral faces which run at an angle of 30° to 90° in relation to the level of the sidewall.

25. The pneumatic vehicle tire as claimed in claim 15, wherein the elevations have lateral faces which run at an angle of 30° to 60° in relation to the level of the sidewall.

26. The pneumatic vehicle tire as claimed in claim 15, wherein the widths of the intermediate spaces between the elevations within a row are 1.00 to 7.00 mm, and between adjacent rows are 1.00 to 5.00 mm.

27. The pneumatic vehicle tire as claimed in claim 15, wherein the widths of the intermediate spaces between the elevations within a row are 2.00 to 7.00 mm, and between adjacent rows are 1.50 to 5.00 mm.

28. The pneumatic vehicle tire as claimed in claim 15, wherein the number of rows is three to five.

29. The pneumatic vehicle tire as claimed in claim 15, wherein the rows on the sidewall cover a sidewall portion which in the radial direction extends between a first height, which is 40% to 50% of the cross-sectional height of the tire, and a second height, which is 80% to 97% of the cross-sectional height of the tire.

30. The pneumatic vehicle tire as claimed in claim 15, wherein the rows run continuously over at least a major part of the circumference of the sidewall.

31. The pneumatic vehicle tire as claimed in claim 15, wherein the rows run continuously over at least three quarters of the circumference of the sidewall.

32. The pneumatic vehicle tire as claimed in claim 15, wherein the intermediate spaces between elevations and/or between adjacent rows are provided with a crosshatch of parallel micro-ribs, with a maximum height of 0.20 mm to 0.30 mm in relation to the sidewall level, and a likewise width at their base.

33. The pneumatic vehicle tire as claimed in claim 32, wherein the micro-ribs are dome-shaped or triangular cross-section.

34. The pneumatic vehicle tire as claimed in claim 32, wherein the micro-ribs also run over surfaces of elevations.
